(19) United States
(12) Patent Application Publication
(10) Pub. No.: US 2016/0151234 A1
(43) Pub. Date: Jun. 2, 2016

(54) Massage Device for Massage Chair or Massage Back Cushion

(71) Applicant: ST LIFE CO., LTD., Taichung City (TW)

(72) Inventor: Jue-Yao Chen, Taichung City (TW)

(21) Appl. No.: 14/556,269

(22) Filed: Dec. 1, 2014

(51) Int. Cl. A61H 15/00

(52) U.S. Cl. CPC A61H 15/0078; A61H 2015/0064

(57) ABSTRACT

A massage device for a massage chair or massage back cushion is provided. The massage device includes: a receiving casing with two sides each provided with an S-shaped track, wherein a rack is disposed at the receiving casing; a vertically movable casing adapted to mesh with the rack and forced to move along the rack; and a swing casing having a top pivotally coupled to the vertically movable casing, having a bottom connected to the vertically movable casing through at least an elastic component, and being flanked by two rollers rolling along the S-shaped tracks. Two massage balls which mesh with gear trains driven by a power source are disposed on the swing casing. The two massage balls each include a rotating disk and two swing arms. The swing casing and massage balls are guided by the S-shaped tracks in feeding or withdrawing along Z-axis and the human back profile.

### BACKGROUND OF THE INVENTION

1. Technical Field

The present invention relates to massage device technology, and more particularly, to a massage device for a massage chair or a massage back cushion, characterized in that: the massage device comprises a vertically movable casing, a swing casing, and two massage units; the vertically movable casing is movable along X-axis; the swing casing and the two massage units enable X-axis movement and Z-axis movement to occur when guided along S-shaped tracks; hence, the massage device is capable of undergoing reciprocating massage motion.

2. Description of Related Art

Referring to Taiwan patent application 089210917, entitled curved rail transmission structure of massage chair, discloses that the curved rail transmission structure essentially comprises a slide base, a bottom cover, a transmission element, an upper cover, and a sealing lid.

The slide base is fixedly disposed on a guide base of a massage chair and comprises two symmetrical lateral frames, wherein the lateral frames each have therein a slide groove.

The bottom cover has therein a fitting recess. The fitting recess has a through hole for communicating with an end portion of the bottom cover. An axial access serving a communication purpose is concavely disposed on each of the two sides of the fitting recess. The bottom cover is slidingly disposed in the slide groove of the slide base.

The transmission element, which is spherical, has a through, threaded hole. A guide bump protrudes from each of two end portions of the threaded hole. A guide post is protrudingly disposed on each of the two opposing sides of the transmission element. The transmission element is disposed in the fitting recess of the bottom cover. The two guide posts are disposed in the axial accesses, respectively.

The upper cover has therein a fitting recess. An axial access serving a communication purpose is concavely disposed on each of the two sides of the fitting recess. The bottom of the fitting recess extends to form a mounting space. The upper cover is slidingly disposed in the slide groove of the slide base to engage with the bottom cover and fit the transmission element through the fitting recess and the axial accesses.

The sealing lid covers an end portion of the slide groove of the slide base, such that the end portion of the slide groove can be closed.

However, the curved rail transmission structure has room for improvement, because it requires screw-driven transmission which incurs high costs, not to mention that there is difficulty in the production and maintenance of the slide grooves concavely disposed at the lateral frames.

### SUMMARY OF THE INVENTION

It is an objective of the present invention to provide a massage device for a massage chair or a massage back cushion, characterized in that: the massage device comprises a vertically movable casing movable along X-axis, and further comprises a swing casing and two massage units which enable X-axis movement and Z-axis movement to occur when guided along S-shaped tracks, thereby allowing the massage device to undergo reciprocating massage motion; the two massage units each include three stereoscopically obliquely guiding slots for effectuating massage variable in depth; and two swing arms of the two massage units maximize the reach of the massage device.

In order to achieve the above and other objectives, the present invention provides a massage device for one of a massage chair and a massage back cushion, comprising: a receiving casing with two sides each provided with an S-shaped track, wherein a rack is disposed at a bottom of the receiving casing; a vertically movable casing, wherein a dovetail is disposed at a bottom of the vertically movable casing and engaged with the rack to restrict the vertically movable casing to X-axis movement, wherein the vertically movable casing has therein a first gear train driven by a motor and adapted to mesh with the rack, and rotation of the motor forces the vertically movable casing to move along X-axis, wherein the first gear train includes a first gear fixedly disposed at a spindle of the motor, integrally formed second upper and lower gears, with the second upper gear meshing with the first gear, integrally formed third upper and lower gears, with the third upper gear meshing with the second lower gear, and integrally formed fourth upper and lower gears, with the fourth upper gear meshing with the third lower gear, wherein the fourth lower gear meshes with the rack; a swing casing, wherein two symmetrical upper shaft holders are fixedly disposed on a top of the swing casing, with a lower shaft holder forwardly and protrudingly disposed on a top of the vertically movable casing, wherein, after being aligned, the upper and lower shaft holders are pivotally penetrated by a shaft, wherein at least an engaging hole is disposed at a lower end of the swing casing, wherein at least an engaging rod is disposed on a front of the vertically movable casing, wherein an end of at least an elastic body is engaged with the engaging hole, and another end of the elastic body is engaged with the engaging rod, wherein a roller is not only disposed on each of the two sides of the swing casing but also adapted to roll along a corresponding one of the S-shaped tracks and force the swing casing to change a feed along Z-axis when guided along the S-shaped tracks; and two massage units flanking the swing casing and disposed in front thereof, wherein the swing casing has therein a bi-directional motor flanked by a second gear train and a third gear train, wherein the bi-directional motor meshes with the second and third gear trains, and the second and third gear trains mesh with two shaft gears fixedly disposed at two shafts of the two massage units, respectively, to drive the two massage units to perform massage characterized by both X-axis movement and Z-axis feeding, wherein the second gear train comprises a fifth gear fixedly disposed at a lateral spindle of the bi-directional motor and integrally formed sixth upper and lower gears, with the sixth upper gear meshing with the fifth gear, and the sixth lower gear meshing with one of the shaft gears, wherein the third gear train comprises a seventh gear fixedly disposed at another lateral spindle of the bi-directional motor and integrally formed eighth upper and lower gears, with the eighth upper gear meshing with the seventh gear, and the eighth lower gear meshing with the other shaft gear. Two massage balls which mesh with gear trains driven by a power source are disposed on the swing casing. The two massage balls each comprise a rotating disk and two swing arms. Hence, the swing casing is forced to ascend and descend as a result of the ascent and descent of the vertically movable casing. The swing casing and the two massage balls are guided by the S-shaped tracks in feeding or withdrawing along both Z-axis and the human back profile. Therefore, the two massage balls are capable of performing massage which curves broadly.

### BRIEF DESCRIPTION OF THE DRAWINGS

FIG. 1 is a plan of an embodiment of the present invention;

FIG. 2 is an exploded view of the embodiment of the present invention;

FIG. 3 is an exploded view of a vertically movable casing and a swing casing according to the present invention;

FIG. 4 is an exploded view of the vertically movable casing taken from below according to the present invention;

FIG. 5 is an exploded view of the swing casing and massage units of the present invention;

FIG. 6 is an exploded view of the swing casing and the massage units according to another embodiment of the present invention;

FIG. 7 is an exploded view of the swing casing of the present invention;

FIG. 8 is an exploded view of the massage units of the present invention;

FIG. 9 is a schematic side view of how the swing casing feeds along Z-axis when guided along S-shaped tracks according to the present invention;

FIG. 10 is a schematic perspective view of how a massage device applies to a massage chair according to the present invention; and

FIG. 11 is a schematic perspective view of how the massage device applies to a massage back cushion according to the present invention.

### DETAILED DESCRIPTION OF THE EMBODIMENT OF THE INVENTION

The present invention provides a massage device for a massage chair or a massage back cushion.

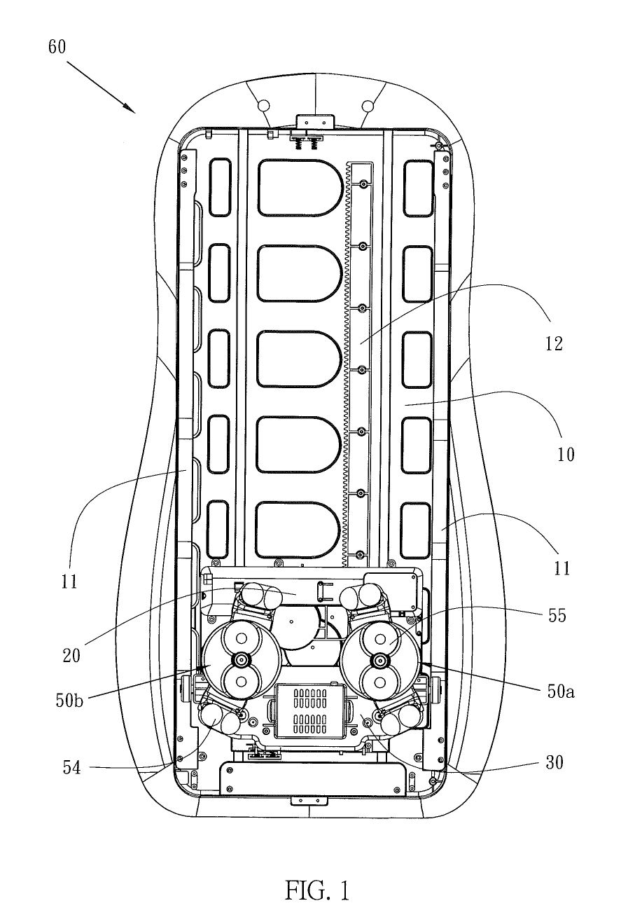

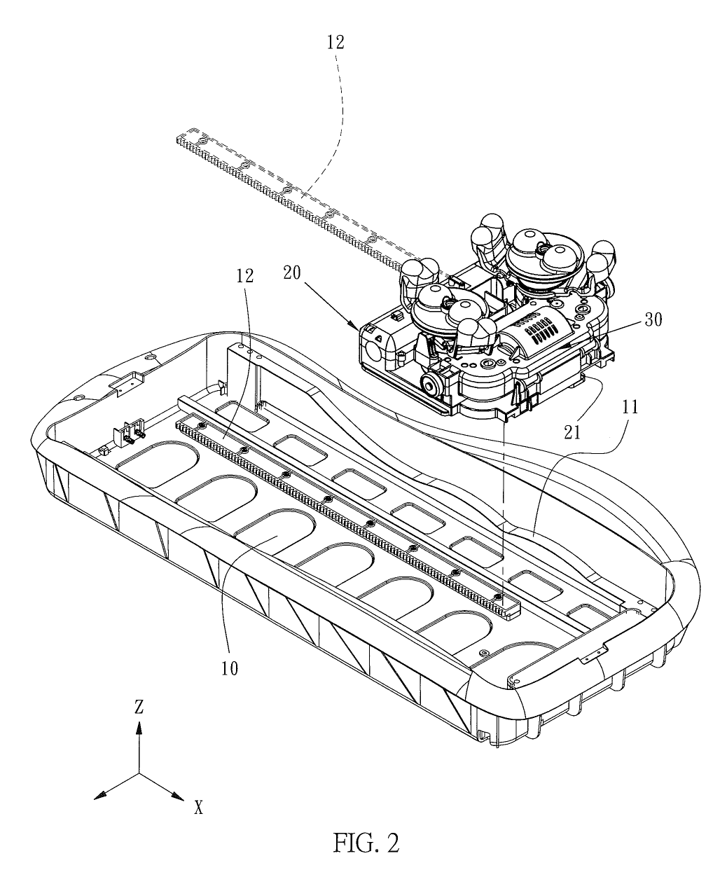

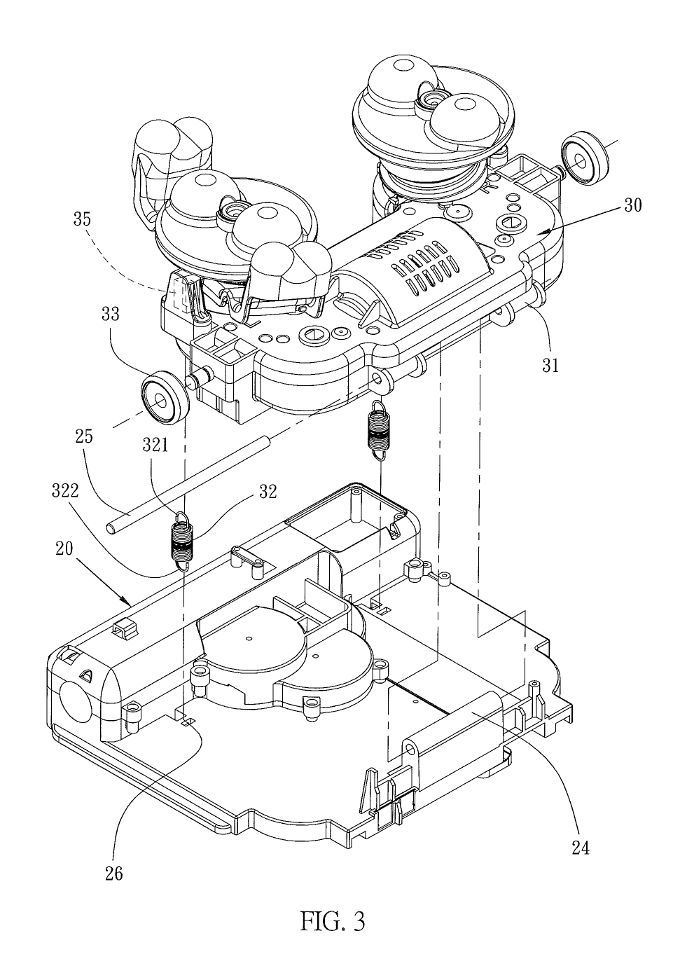

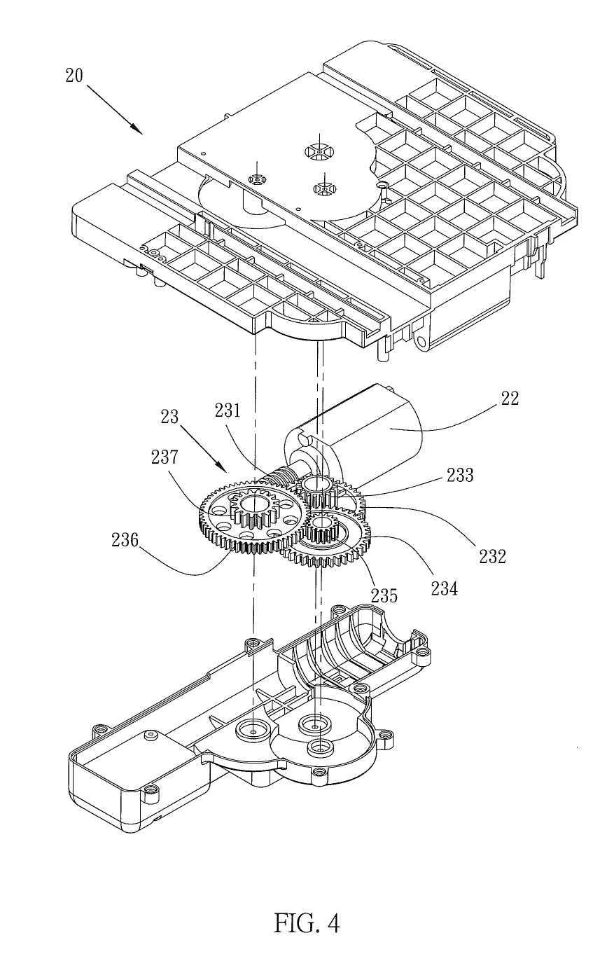

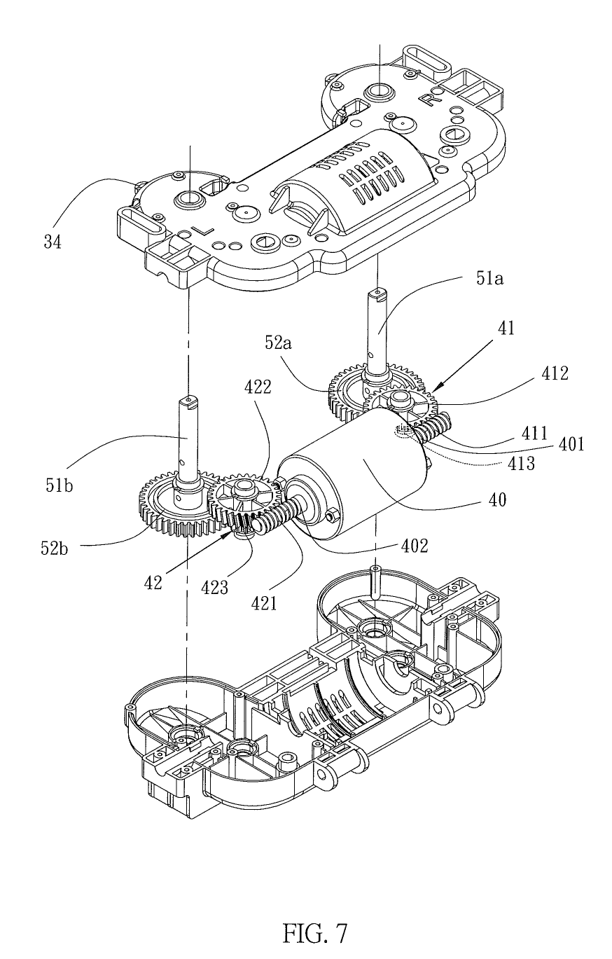

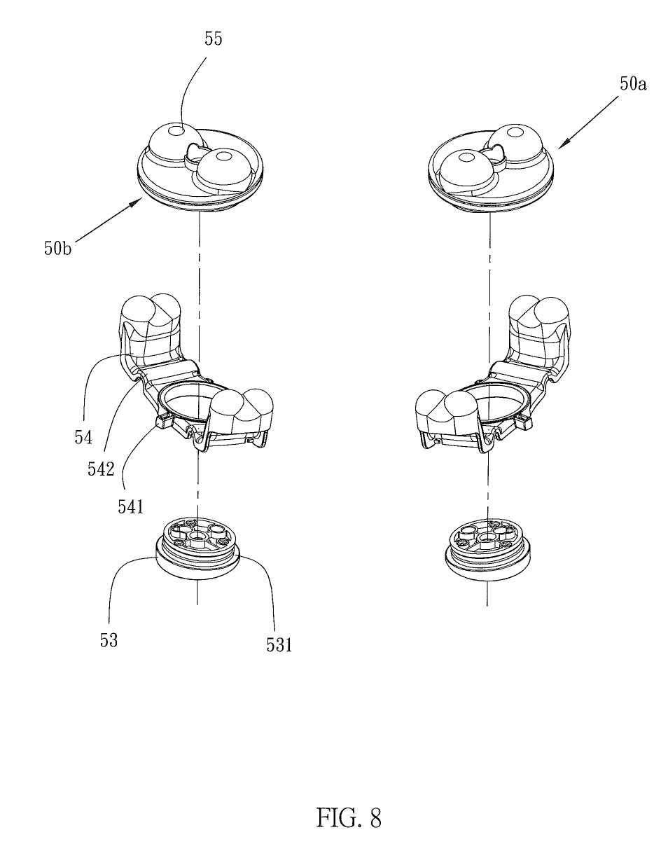

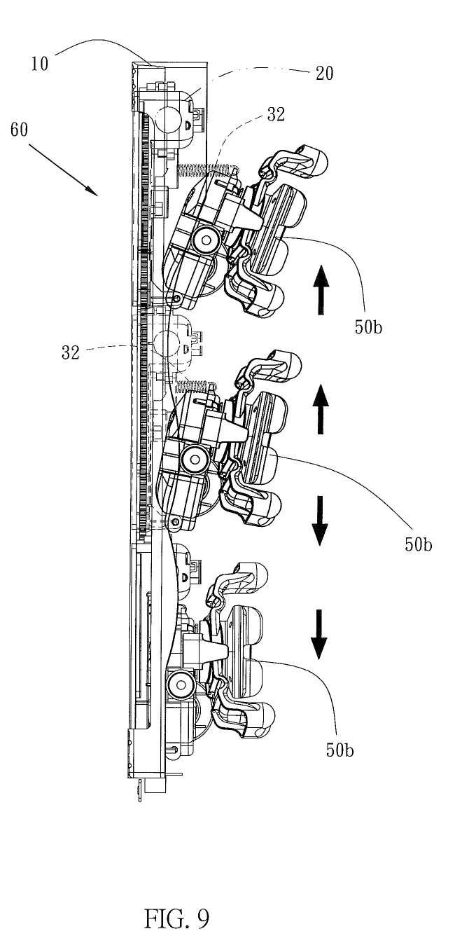

Referring to FIG. 1 through FIG. 9, the present invention provides a massage device for a massage chair or a massage back cushion. The massage device comprises a receiving casing 10, a vertically movable casing 20, a swing casing 30, and first and second massage units 50a, 50b.

The receiving casing 10 has two sides each provided with an S-shaped track 11. A rack 12 is disposed at the bottom of the receiving casing 10.

A dovetail 21 is disposed at the bottom of the vertically movable casing 20. The dovetail 21 is engaged with the rack 12 to restrict the vertically movable casing 20 to X-axis movement. The vertically movable casing 20 has therein a first gear train 23 driven by a motor 22. The first gear train 23 meshes with the rack 12. With the motor 22 operating, the vertically movable casing 20 must undergo X-axis movement.

Two symmetrical upper shaft holders 31 are fixedly disposed on the top of the swing casing 30. A lower shaft holder 24 is forwardly and protrudingly disposed on the top of the vertically movable casing 20. After being aligned, the upper and lower shaft holders 31, 24 are pivotally penetrated by a shaft 25. At least an engaging hole 34 is disposed at the lower end of the swing casing 30. At least an engaging rod 26 is disposed on the front of the vertically movable casing 20. One end 321 of at least an elastic body 32 is engaged with the engaging hole 34. The other end 322 of the elastic body 32 is engaged with the engaging rod 26. A roller 33 is not only disposed on each of the two sides of the swing casing 30 but also adapted to roll along a corresponding one of the S-shaped tracks 11 and force the swing casing 30 to change the feed along Z-axis when guided along the S-shaped tracks 11.

The first and second massage units 50a, 50b flank the swing casing 30 and are disposed in front thereof. The swing casing 30 has therein a bi-directional motor 40. The bi-directional motor 40 is flanked by a second gear train 41 and a third gear train 42. The bi-directional motor 40 meshes with the second and third gear trains 41, 42. The second and third gear trains 41, 42 mesh with first and second shaft gears 52a, 52b fixedly disposed at first and second shafts 51a, 51b of the first and second massage units 50a, 50b, respectively, to drive the first and second massage units 50a, 50b to rotate.

As indicated above, the aforesaid parts and components are put together to form a massage device 60.

Regarding a massage device for a massage chair or a massage back cushion according to the present invention, the elastic body 32 is a spring.

Regarding a massage device for a massage chair or a massage back cushion according to the present invention, the first and second massage units 50a, 50b which mesh with the second and third gear trains 41, 42 driven by a power source are disposed on the swing casing 30. The first and second massage units 50a, 50b are configured to undergo rotation movement carried out with massaging balls 55 and kneading movement carried out with two integrally formed swing arms 54. Hence, the swing casing 30 is forced to ascend and descend as a result of the ascent and descent of the vertically movable casing 20. The swing casing 30 and the first and second massage units 50a, 50b are guided by the S-shaped tracks 11 in feeding or withdrawing along both Z-axis and the human back profile. Therefore, the first and second massage units 50a, 50b are capable of performing massage which curves broadly.

Regarding a massage device for a massage chair or a massage back cushion according to the present invention, the first gear train 23 comprises a first gear 231 fixedly disposed at a spindle of the motor 22, integrally formed second upper and lower gears 232, 233, with the second upper gear 232 meshing with the first gear 231, integrally formed third upper and lower gears 234, 235, with the third upper gear 234 meshing with the second lower gear 233, and integrally formed fourth upper and lower gears 236, 237, with the fourth upper gear 236 meshing with the third lower gear 235, wherein the fourth lower gear 237 meshes with the rack 12.

Regarding a massage device for a massage chair or a massage back cushion according to the present invention, the second gear train 41 comprises a fifth gear 411 fixedly disposed at a lateral spindle 401 of the bi-directional motor 40 and integrally formed sixth upper and lower gears 412, 413, with the sixth upper gear 412 meshing with the fifth gear 411, and the sixth lower gear 413 meshing with the first shaft gear 52a.

Regarding a massage device for a massage chair or a massage back cushion according to the present invention, the third gear train 42 comprises a seventh gear 421 fixedly disposed at another lateral spindle 402 of the bi-directional motor 40 and integrally formed eighth upper and lower gears 422, 423, with the eighth upper gear 422 meshing with the seventh gear 421, and the eighth lower gear 423 meshing with the second shaft gear 52b.

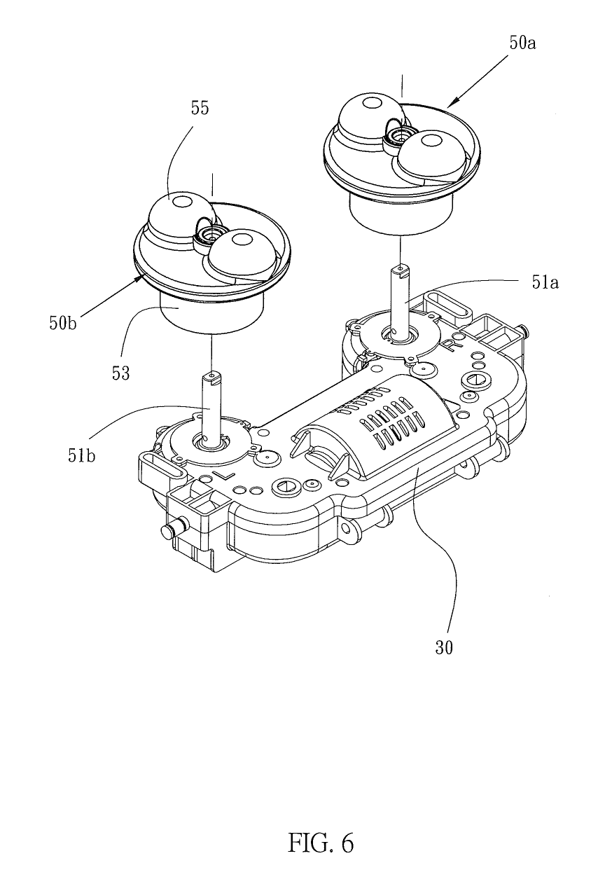

Referring to FIG. 6, regarding a massage device for a massage chair or a massage back cushion according to the present invention, the first and second massage units 50a, 50b each comprise a rotating disk 53 and at least a massaging ball 55 mounted on the rotating disk 53.

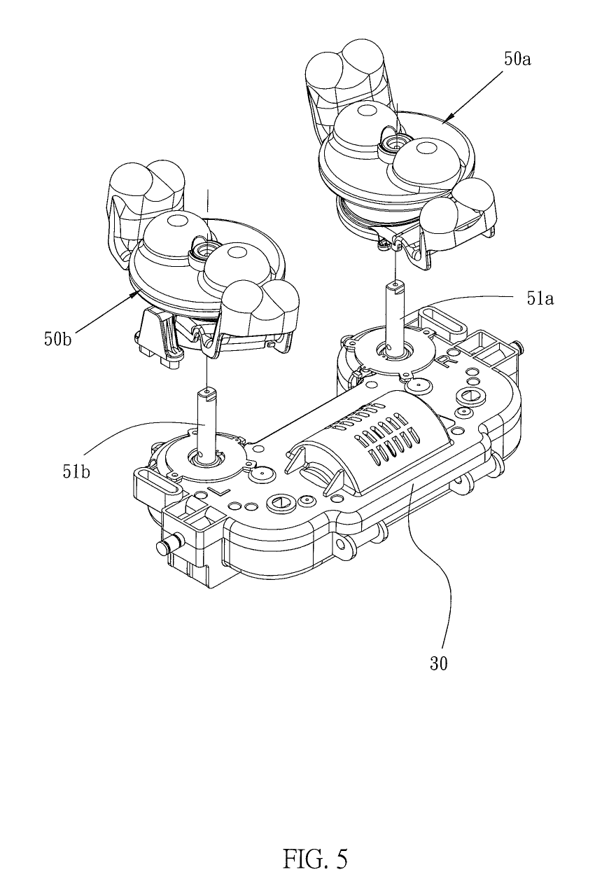

Referring to FIGS. 5, 7, 8, regarding a massage device for a massage chair or a massage back cushion according to the present invention, the first and second massage units 50a, 50b each comprise a rotating disk 53, two integrally formed swing arms 54, and a massaging ball 55. Three stereoscopically obliquely guiding slots 531 are disposed on the rotating disk 53. The swing arms 54 fit the stereoscopically obliquely guiding slots 531 on the rotating disk 53 and are fixedly connected to the rotating disk 53 through the massaging ball 55. The two swing arms 54 each have a protruding post 541. A limiting slit 35 corresponding in position to the protruding post 541 is disposed at the swing casing 30 to restrict the range of motion of the protruding post 541, such that the two swing arms 54 undergo kneading movement when guided along the stereoscopically obliquely guiding slots 531 and restricted by the limiting slit 35. The two swing arms 54 each have a resilient groove 542 for enhancing the resilience of the two swing arms 54.

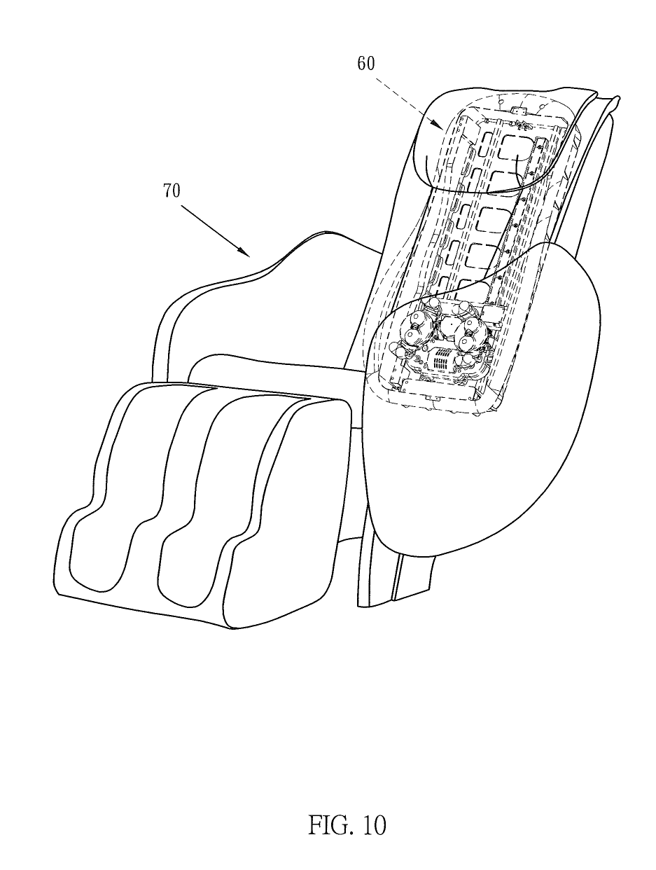

Referring to FIG. 10, regarding a massage device for a massage chair or a massage back cushion according to the present invention, the massage device 60 fits inside a massage chair 70, such that a person sitting in the massage chair 70 can have his or her back and neck resting against the massage device 60 and massaged by the massage device 60.

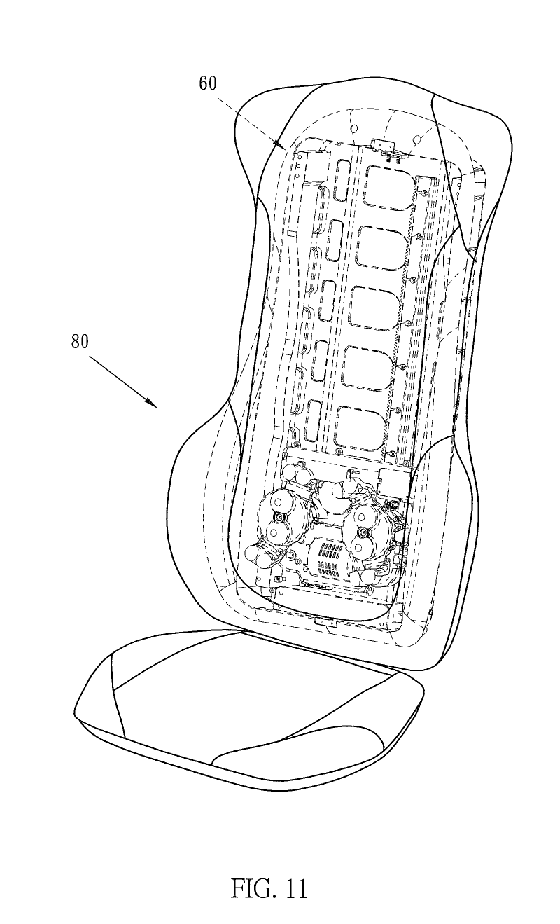

Referring to FIG. 11, regarding a massage device for a massage chair or a massage back cushion according to the present invention, the massage device 60 fits inside a massage back cushion 80, such that a person sitting in the massage back cushion 80 can have his or her back and neck resting against the massage device 60 and massaged by the massage device 60.

As indicated above, the present invention provides a massage device for a massage chair or a massage back cushion. The massage device is novel and thus meets the novelty requirement of an invention patent. The massage device is comprehensively innovative and thus meets the non-obviousness requirement of an invention patent. The massage device comprises a vertically movable casing which is movable along X-axis, and further comprises a swing casing and two massage units which enable X-axis movement and Z-axis movement to occur when guided along S-shaped tracks, and thus the massage device is capable of undergoing reciprocating massage motion, thereby having high industrial applicability.

What is claimed is:

1. A massage device for one of a massage chair and a massage back cushion, comprising:
a receiving casing with two sides each provided with an S-shaped track, wherein a rack is disposed at a bottom of the receiving casing;
a vertically movable casing, wherein a dovetail is disposed at a bottom of the vertically movable casing and engaged with the rack to restrict the vertically movable casing to X-axis movement, wherein the vertically movable casing has therein a first gear train driven by a motor and adapted to mesh with the rack, and rotation of the motor forces the vertically movable casing to move along X-axis, wherein the first gear train includes a first gear fixedly disposed at a spindle of the motor, integrally formed second upper and lower gears, with the second upper gear meshing with the first gear, integrally formed third upper and lower gears, with the third upper gear meshing with the second lower gear, and integrally formed fourth upper and lower gears, with the fourth upper gear meshing with the third lower gear, wherein the fourth lower gear meshes with the rack;
a swing casing, wherein two symmetrical upper shaft holders are fixedly disposed on a top of the swing casing, with a lower shaft holder forwardly and protrudingly disposed on a top of the vertically movable casing, wherein, after being aligned, the upper and lower shaft holders are pivotally penetrated by a shaft, wherein at least an engaging hole is disposed at a lower end of the swing casing, wherein at least an engaging rod is disposed on a front of the vertically movable casing, wherein an end of at least an elastic body is engaged with the engaging hole, and another end of the elastic body is engaged with the engaging rod, wherein a roller is not only disposed on each of the two sides of the swing casing but also adapted to roll along a corresponding one of the S-shaped tracks and force the swing casing to change a feed along Z-axis when guided along the S-shaped tracks; and
two massage units flanking the swing casing and disposed in front thereof, wherein the swing casing has therein a bi-directional motor flanked by a second gear train and a third gear train, wherein the bi-directional motor meshes with the second and third gear trains, and the second and third gear trains mesh with two shaft gears fixedly disposed at two shafts of the two massage units, respectively, to drive the two massage units to perform massage characterized by both X-axis movement and Z-axis feeding, wherein the second gear train comprises a fifth gear fixedly disposed at a lateral spindle of the bi-directional motor and integrally formed sixth upper and lower gears, with the sixth upper gear meshing with the fifth gear, and the sixth lower gear meshing with one of the shaft gears, wherein the third gear train comprises a seventh gear fixedly disposed at another lateral spindle of the bi-directional motor and integrally formed eighth upper and lower gears, with the eighth upper gear meshing with the seventh gear, and the eighth lower gear meshing with the other shaft gear.

2. The massage device of claim 1, wherein the elastic body is a spring.

3. The massage device of claim 1, wherein the two massage units are symmetrical to each other and each comprise a rotating disk and at least a massaging ball mounted on the rotating disk.

4. The massage device of claim 1, wherein the two massage units are symmetrical to each other and each comprise a rotating disk, two integrally formed swing arms, and a massaging ball, wherein three stereoscopically obliquely guiding slots are disposed on the rotating disk, wherein the swing arms fit the stereoscopically obliquely guiding slots on the rotating disk and are fixedly connected to the rotating disk through the massaging ball, wherein the two swing arms each have a protruding post, wherein a limiting slit corresponding in position to the protruding post is disposed at the swing casing to restrict the range of motion of the protruding post, such that the two swing arms undergo kneading movement when guided along the stereoscopically obliquely guiding slots and restricted by the limiting slit, wherein the two swing arms each have a resilient groove for enhancing resilience of the two swing arms.

5. The massage device of claim 1, wherein the massage device fits inside a massage chair.

6. The massage device of claim 1, wherein the massage device fits inside a massage back cushion.
